(19) United States
(12) Patent Application Publication
(10) Pub. No.: US 2014/0185052 A1
(43) Pub. Date: Jul. 3, 2014

(54) FOURIER-TRANSFORM SPECTROMETER AND METHOD

(71) Applicant: Qiushui Chen, Andover, MA (US)

(72) Inventor: Qiushui Chen, Andover, MA (US)

(21) Appl. No.: 13/727,782

(22) Filed: Dec. 27, 2012

(51) Int. Cl. G01B 9/02

(52) U.S. Cl. CPC G01B 9/02
USPC 356/453

(57) ABSTRACT

The present invention is related to a Fourier-transform spectrometer arrangement comprising a first polarizer, a birefringent plate, a pair of birefringent wedges, a second polarizer, a photo detector, and a control unit. According to the invention, the cross sections of the two birefringent wedges of the birefringent wedge pair are similar triangles, the first wedge is fixed, the second wedge is capable of linearly movement along the side, the optic axes of the pair of birefringent wedges are parallel to each other and orthogonal to the optic axis of the birefringent plate, the polarization of the first polarizer is in 45 degrees with the optical axis of the birefringent plate, the polarization of the first polarizer is also in 45 degrees with the optical axis of the pair of birefringent wedges, the polarization of the second polarizer is parallel, or orthogonal, to the polarization of the first polarizer.

### THE TECHNICAL FIELD

The current technology relates to birefringence Fourier-transform spectroscopy, more specifically, it relates to a high sensitive Fourier-transform spectrometer with s fixed birefringent wedge and a moving birefrigent wedge, and a method for controlling the birefringent Fourier-transform spectrometer.

### BACKGROUND

There is a variety of reasons that scientists and engineers need higher and higher sensitivity in spectroscopy. Some of the challenging low light applications include Raman spectroscopy, flow-cytometry, multi-track Raman spectroscopy, pump-probe spectroscopy, and multi-object fiber spectroscopy in astronomy.

Fourier-transform spectroscopy offers important advantages over other spectral modalities, such advantages include a wider free spectral range, higher spectral resolutions, and in low-photon-flux conditions, higher signal-to-noise ratios.

Traditional Fourier-transform instruments are based on moving mirror interferometers; such instruments are bulky and inherently sensitive to air current and vibration. They are accordingly not suitable for deployment in harsh environments, or environments where a compact design is preferred.

One of the low-photon-flux applications is multi-object fiber spectroscopic telescope in astronomy. The goal of such a telescope is to conduct a wide-field survey to achieve the following: 1). an extra-galactic spectroscopic survey to shed light on the large scale structure of the universe; 2). a stellar spectroscopic survey, including a search for metal-poor stars in the galactic halo, to provide information on the structure of our Galaxy; and 3). cross-identification of multi-waveband surveys.

One of the implementations of such a multi-object fiber spectroscopic telescope comprises two roughly rectangular mirrors, each made up of a number of 1.1 meter hexagonal deformable segments, providing focal plane of 1.75 meter in diameter corresponding to a five-degree field of view. The available large focal plane is tilted with fiber-positioning units and attached to 4000 fibers, through which the collected light of distant and faint celestial objects down to 20.5 magnitude is fed into a plurality of spectrometers, promising a very high spectrum acquiring rate of ten-thousands of spectra per night. A high spectral resolution mode of the telescope can operate in the range of 510 nm-540 nm and 830 nm-890 nm.

### SUMMARY OF INVENTION

The present invention provides devices and methods for full aperture, high sensitive and vibration-resistant Fourier-transform spectroscopy. The advantages of the current invention includes, but are not limited to, insensitivity to air current, reduced sensitivity to mechanical vibration, and more tolerance to movement error. The current invention has special advantages in short wavelength range.

In accordance with the present invention, a Fourier-transform spectrometer arrangement comprises: a first polarizer; a birefringent plate; a pair of birefringent wedges; a second polarizer; a photo detector for receiving and recording output optical signal; and a control unit for receiving data and computing resulting spectrum, wherein the first polarizer polarizes an incoming radiation beam into linearly polarized beam; wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air; wherein the first wedge is fixed, and the second wedge is capable of linearly movement along the side; wherein the optic axes of the pair of birefringent wedges are parallel to each other and orthogonal to the optic axis of the birefringent plate; wherein the polarization of the first polarizer is in 45 degrees with the optical axis of the birefringent plate, and the polarization of the first polarizer is also in 45 degrees with the optical axis of the pair of birefringent wedges; wherein the polarization of the second polarizer is parallel, or orthogonal, to the polarization of the first polarizer.

In another aspect of the present invention, a Fourier-transform spectrometer arrangement further comprises: a track parallel to the side of the moving wedge; a holder capable of moving along the track and in rigid physical contact with the moving wedge; a motion mechanism in mechanical contact with the holder and the moving wedge; a motion controller in electronic connection with the motion mechanism to control the motion; a displacement sensor unit for reading out position information from the wedge; and a control unit, in electronic connection with the decoder to receive position information of the moving wedge, in electronic connection with the photo detector for receiving radiation intensity information.

In another aspect of the present invention, a method for performing Fourier-transform analysis comprises the steps of: polarizing an incoming beam of radiation into linearly polarized beams; passing the linearly polarized beams through a birefrigent plate; passing the beams through a pair of birefringent wedges; passing the beams through a second polarizer; detecting the resulting beam signal with a photo detector; sending the information detected by the photo detector to a control unit; adjusting the position of the moving wedge and detecting a new signal in the photo detector; and repeating the process of adjusting the position of the moving wedge and computing the spectrum from of the incoming radiation, wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air; wherein the first wedge is fixed, and the second wedge is capable of linearly movement along the side; wherein the optic axes of the pair of birefringent wedges are parallel to each other and orthogonal to the optic axis of the birefringent plate; wherein the polarization of the first polarizer is in 45 degrees with the optical axis of the birefringent plate, and the polarization of the first polarizer is also in 45 degrees with the optical axis of the pair of birefringent wedges; wherein the polarization of the second polarizer is parallel, or orthogonal, to the polarization of the first polarizer.

In accordance with an alternative embodiment of the present invention, a Fourier-transform spectrometer arrangement comprises: a polarizing beam splitter; a birefringent plate; a pair of birefringent wedges; a polarizing beam combiner; a photo detector for receiving and recording output optical signal; and a control unit for receiving data and computing resulting spectrum, wherein the polarizing beam splitter splits an incoming radiation beam into two orthogonal linearly polarized beams; wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air; wherein the first wedge is fixed, and the second wedge is capable of linearly movement along the side; wherein the optic axes of the pair of birefringent wedges are parallel to each other and orthogonal to the optic axis of the birefringent plate.

In another aspect of the present invention, a Fourier-transform spectrometer arrangement further comprises: a track parallel to the side of the moving wedge; a holder capable of moving along the track and in rigid physical contact with the moving wedge; a motion mechanism in mechanical contact with the holder and the moving wedge; a motion controller in electronic connection with the motion mechanism to control the motion; a position measurement unit for reading out position information from the wedge; and a control unit, in electronic connection with the decoder to receive position information of the moving wedge, in electronic connection with the photo detector for receiving radiation intensity information.

In accordance with an alternative embodiment of the present invention, a method for performing Fourier-transform analysis comprising the steps of: splitting an incoming beam of radiation into two orthogonal linearly polarized beams; passing the linearly polarized beams through a birefrigent plate; passing the beams through a pair of birefringent wedges; passing the beams through a polarizing beam combiner; detecting the resulting beam signal with a photo detector; sending the information detected by the photo detector to a control unit; adjusting the position of the moving wedge and detecting a new signal in the photo detector; and repeating the process of adjusting the position of the moving wedge and computing the spectrum from of the incoming radiation, wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air; wherein the first wedge is fixed, and the second wedge is capable of linearly movement along the side; wherein the optic axes of the pair of birefringent wedges are parallel to each other and orthogonal to the optic axis of the birefringent plate.

According to the current invention, it is especially suited for short wavelength full aperture Fourier transform spectroscopy. A wavelength range of 200 nm to 4800 nm can be implemented by the current invention. The working spectral range depends on the transmission ranges of birefringent materials used, such materials include, but not limited to, CaCO₃, BBO, quartz, YVO₄, etc.

### BRIEF DESCRIPTIONS OF THE DRAWINGS

In the accompanying drawings, reference characters refer to the same parts throughout the different views. The drawings are not necessarily to scale; emphasis has been placed upon illustrating the principles of the invention. Of the drawings:

FIG. 1 is a schematic illustration of a general structure of a high sensitive Fourier-transform spectrometer with a pair of birefringent wedges.

FIG. 1A is a schematic illustration of the detailed structure of a pair of birefringent wedges and the details of geometry of the optics.

FIG. 2 is a schematic illustration of an alternative embodiment of a high sensitive Fourier-transform spectrometer with a pair of birefringent wedges.

FIG. 2A is a schematic illustration of the detailed structure of a pair of birefringent wedges and the details of geometry of the optics of an alternative embodiment of the current invention.

FIG. 3 is a schematic illustration of the moving mechanism of the moving birefringent wedge.

FIG. 4 is a schematic illustration of yet another alternative configuration of a high sensitive Fourier-transform spectrometer with a pair of birefringent wedges.

FIG. 5 is a schematic illustration of still another alternative configuration of a high sensitive Fourier-transform spectrometer with a pair of birefringent wedges.

FIG. 6 is an example of a broadband source.

FIG. 7 is an example of a laser source of 1.55 μm wavelength.

### DETAILED DESCRIPTION

The Figures (FIG.) and the following description relate to the preferred embodiments of the present invention by way of illustration only. It should be noted that from the following discussion, alternative embodiments of the structures and methods disclosed herein will be readily recognized as viable alternatives that may be employed without departing from the principles of the claimed inventions.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

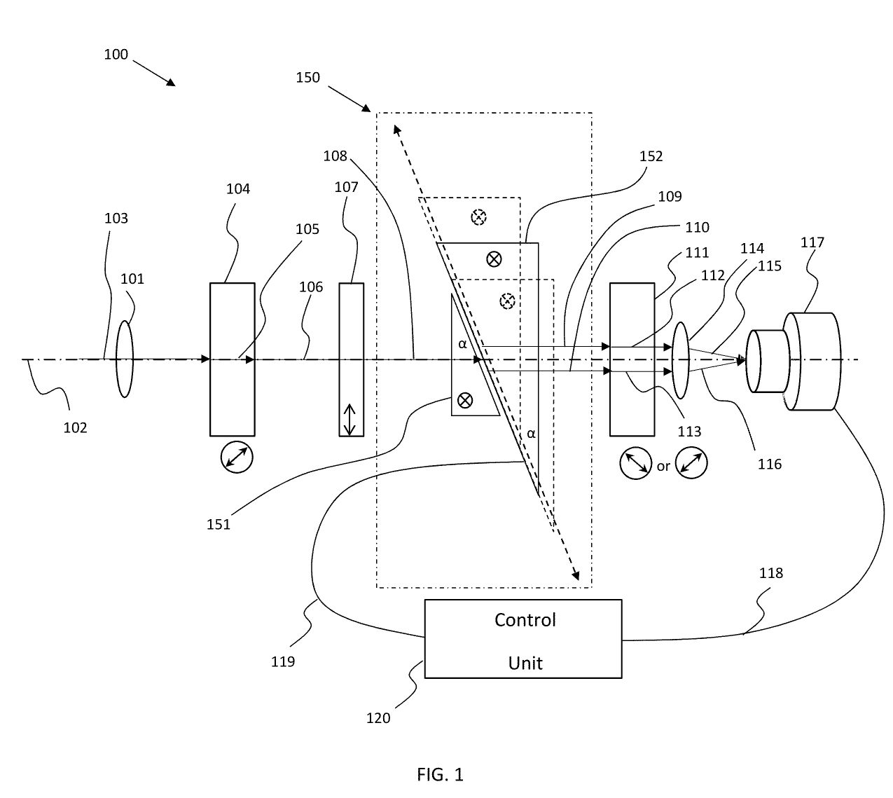

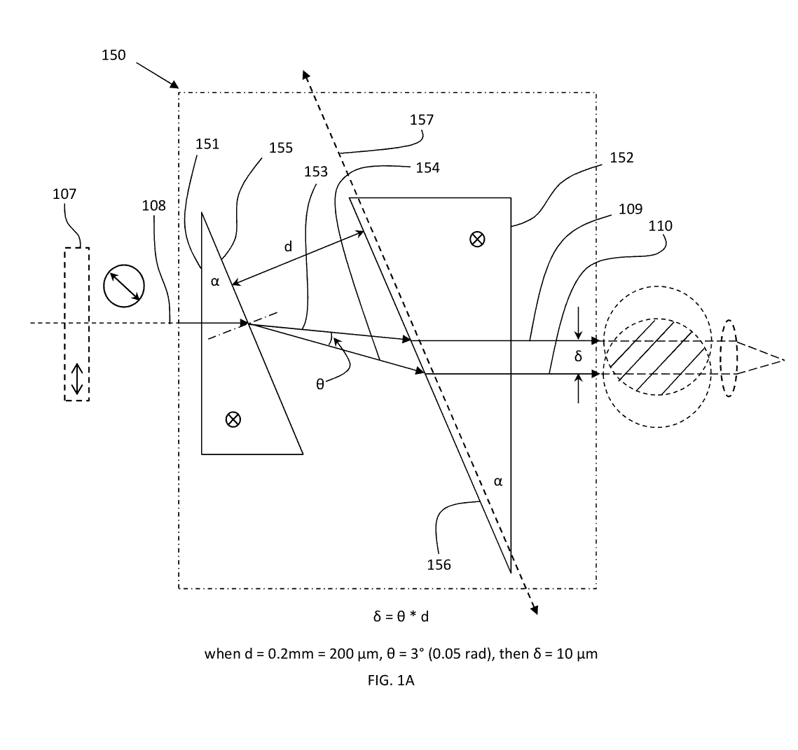

As shown in FIG. 1, the high sensitive Fourier-transform spectrometer 100 comprises: a collecting lens 101, a first polarizer 104, a birefringent plate 107, a pair of birefringent wedges 150 comprising a fixed wedge 151 and a moving wedge 152, a second polarizer 111, a focusing lens 114, a high sensitive photo detector 117 and a control unit 120.

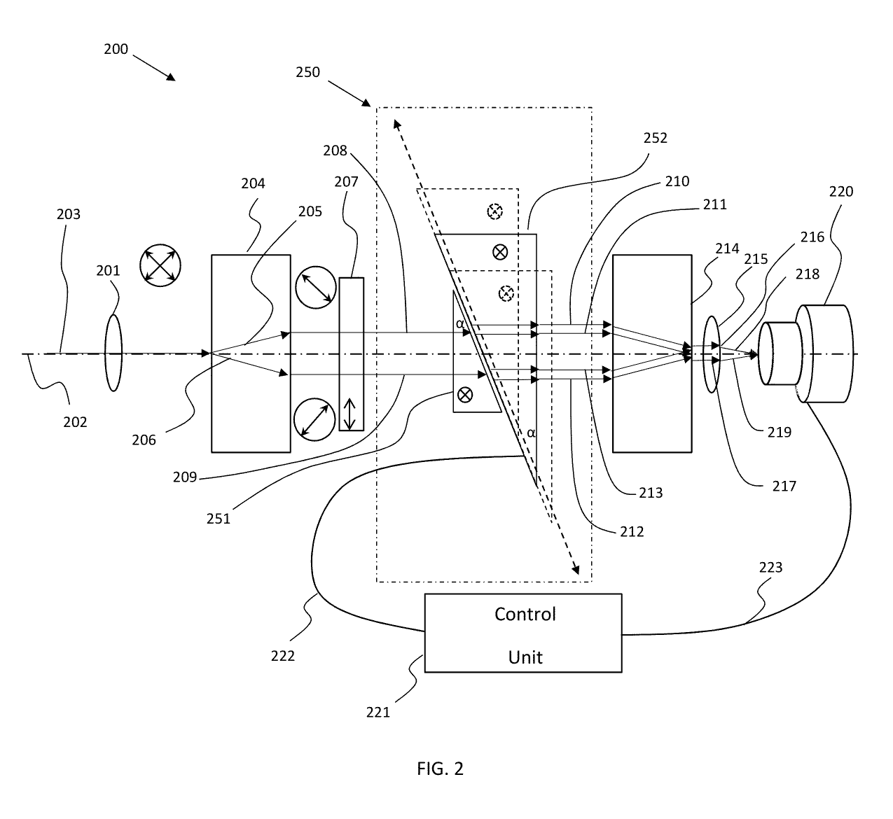

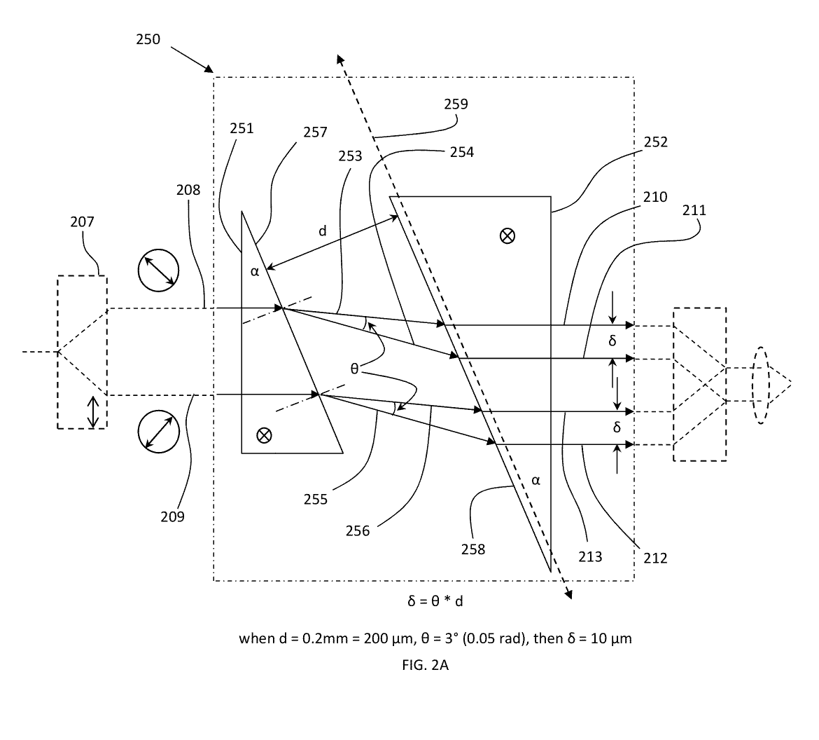

The collecting lens 101 positioned along the optical axis 102, the radiation beam, or light beam, 103 emitted by a radiation source travels along the optical axis 102, the collecting lens 101 collects the radiation 103 and passes to the first polarizer 104, which polarizes incoming light 103. The polarized light 106 is then sent into the birefringent plate 107, where linearly polarized light beams 106 becomes beam 108. The pair of birefringent wedges 150 comprises the fixed wedge 151 and the moving wedge 152, where the fixed wedge 151 and the moving wedge 152 are similar triangles with same wedge angle α, the corresponding sides of the fixed wedge 151 and the corresponding sides of the moving wedge 152 are parallel to each other. The optical axis of the fixed wedge 151 and the moving wedge 152 are parallel to each other, and at the same time, the optical axis of the birefringent plate 107 is orthogonal to the optical axis of both the fixed wedge 151 and the moving wedge 152. The angle between the polarization of the first polarizer 104 and the optical axis of the birefringent plate 107 is 45 degrees, and the angle between the polarization of the first polarizer 104 and the optical axis of both the fixed wedge 151 and the moving wedge 152 is also 45 degrees. The linearly polarized beam 108 is further split into beam 109 and beam 110, where the details of the geometry and optics between the fixed wedge 151 and the moving wedge 152 are explained in FIG. 2. The polarization of the second polarizer 111 is parallel, or perpendicular, to the polarization of the first polarizer 104, beam 109 becomes beam 112, beam 110 becomes beam 113, beams 112 and 113 are then passed into the focusing lens 114, beams 112 and 113 are focused and then become beams 115 and 116. The beams 115 and 116 are then sent into the high sensitive photo detector 117, the detected signal is then sent to the control unit 120 for further processing through cable 118. The control unit also receives signals that represents positions of the moving wedge 152 through cable 119.

As shown in FIG. 1A, a detailed structure of the pair of birefringent wedges 150 and the details of geometry of the optics. The pair of birefringent wedges 150 comprising the fixed wedge 151 and the moving wedge 152, wherein the fixed wedge 151 and the moving wedge 152 are similar triangles with same wedge angle α, the corresponding sides of the fixed wedge 151 and the corresponding sides of the moving wedge 152 are parallel to each other. The optical axis of the fixed wedge 151 and the moving wedge 152 are parallel to each other and the optical axis of the birefringent plate 107 is orthogonal to the optical axis of both the fixed wedge 151 and the moving wedge 152. The linearly polarized beam 108 is further split into beam 153 and beam 154. When the fully linearly polarized beam 108 reaches the side 155 of the fixed wedge 151, the beam 108 is split into beams 153 and 154, the angle between beam 153 and beam 154 is θ, and θ is very small, for example, θ=3° (0.05 rad). θ can be estimated by the formula: θ≈b·α, where b is the birefringence of the material, b=nₒ−nₑ, where nₒ and nₑ are the ordinary and extraordinary refractive indices, α is the wedge angle. For example, when b=0.1, and α=16°, θ≈b·α=1.6°. The side 155 of the fixed wedge 151 and the side 156 of the moving wedge 152 are parallel to each other, the side 155 and the side 156 are separated by air, the distance between the side 155 and the side 156 is d, d is very small, for example, d=0.2 mm=200 μm. When the moving wedge 152 moves along the direction 157, side 155 and side 156 are always parallel to each other and the distance d is maintained as a constant. When beams 153 and 154 reach side 156, they become beams 109 and 110, respectively, the distance between beams 109 and 110 is δ, an estimate of δ based on d and θ is: δ˜d·θ˜10 μm. Typical wedges available on the market possess cross section of right triangle, or isosceles triangle, but it is obvious for one skilled in the art that the cross sections of the birefringent wedges do not have to be right triangle or isosceles triangle, such cross sections are not meant to limit the scope of current invention.

The optical path difference introduced by the pair of birefringent wedges between orthogonal polarization states of a normally incident radiation with a small splitting angle is given by the approximation: Δ_{OP}≈2s·b·tan α, where s is the displacement of the radiation from the centerline of the wedge, and b=nₒ−nₑ is the birefringence of the wedge material, where nₒ and nₑ are the ordinary and extraordinary refractive indices, α is the wedge angle.

If τ₁ and τ₂ are amplitude transmittances of the two polarizers, then the amplitude of the optical field at a particular pixel at an optical angular frequency ω, in a small interval of optical frequencies dω, and at a prism displacement, h, is given by:

ε_{T}(ω,h)dω=τ₁·τ₂·ε(ω)[exp(i·ω·(t+h·b·tan α/c))±exp(i·ω·(t−h·b·tan α/c))]dω,

where ε₀ (ω) is the amplitude of the light incident upon the first polarizer, t is the time and c is the speed of light. The sign of the second term is positive if the polarizers are co-aligned (parallel) and negative if they are crossed (orthogonal). The intensity of the recombined beams is then:

I(ωh)dω=2·ε₀²(ω)·|τ₁·τ₂|²·[1±cos(2·ω·b·h·tan α/c)]dω

Integrating the total flux at the displacement h for all frequencies yields:

I(h)=2·|τ₁·τ₂|²·(I₀±∫₀^{∞}I₀(ω)·cos(2·ω·b·h·tan α/c)dω)

where I₀ is a bias term and I(ω)=ε₀(ω)² is the spectral intensity at frequency ω. The interferogram is sampled with sampling interval Δₕ such that the Nyquist criterion for the short-wavelength cutoff of the system spectral response is obeyed. Discrete inverse Fourier transformation of the sampled interferogram yields the spectral distribution, which is sampled at the values:

$${σ}_{i} = i \cdot \frac{1}{2 \cdot b \cdot {σ}_{i} \cdot N \cdot {Δ}_{h} \cdot tan α}$$

where σ=ω/2π=1/λ, N is the number of samples in the interferogram and I ranges from 0 to N/2.

As shown in FIG. 2, in an alternative embodiment, the high sensitive Fourier-transform spectrometer 200 comprises: a collecting lens 201, a beam-splitting polarizer 204, a birefringent plate 207, a pair of birefringent wedge 250 comprising a fixed wedge 251 and a moving wedge 252, a polarizing beam combiner 214, a focusing lens 215, a high sensitive photo detector 220 and a control unit 221.

The collecting lens 201 is positioned along the optical axis 202, a radiation beam, or light beam, 203 emitted by a radiation source travels along the optical axis 202. The collecting lens 201 collects radiation and passes to the beam-splitting polarizer 204 which splits incoming light 203 into two beams of fully linearly polarized light beams 205 and 206 with orthogonal polarizations. The birefringent plate 207, wherein linearly polarized light beam 205 becomes beam 208 and linearly polarized light beam 206 becomes beam 209. The pair of birefringent wedge 250 comprises the fixed wedge 251 and the moving wedge 252, where the fixed wedge 251 and the moving wedge 252 are similar triangles and the corresponding sides of the fixed wedge 251 and the corresponding sides of the moving wedge 252 are parallel to each other. The optical axis of the fixed wedge 251 and the moving wedge 252 are parallel to each other, the optical axis of the birefringent plate 207 is orthogonal to the optical axis of both the fixed wedge 251 and the moving wedge 252. The linearly polarized beam 208 is further split into beam 210 and beam 211, the linearly polarized beam 209 is further split into beam 212 and beam 213. The details of the geometry and optics between the sides of the fixed wedge 251 and the moving wedge 252 are explained in FIG. 2A. The polarizing beam combiner 214 combines light beams 210, 211, 212 and 213 into light beams 216 and 217 and then passed into the focusing lens 215. The beams 216 and 217 are then focused into beams 218 and 219 and passed into the high sensitive photo detector 220. The detected signal is sent to a control unit 221 for further processing through a cable 223. The control unit also receives signals that represents positions of the moving wedge 252 through a cable 222.

As shown in FIG. 2A, a detailed structure of the pair of birefringent wedges 250 and the details of geometry of the optics. The pair of birefringent wedge 250 comprises the fixed wedge 251 and the moving wedge 252. The fixed wedge 251 and the moving wedge 252 are similar triangles, the side 257 of the fixed wedge 251 and the side 258 the moving wedge 252 are parallel to each other. The optical axis of the fixed wedge 251 and the moving wedge 252 are parallel to each other and the optical axis of the birefringent plate 207 is orthogonal to the optical axis of both the fixed wedge 251 and the moving wedge 252. A linearly polarized beam 208 is further split into a beam 210 and a beam 211, A linearly polarized beam 209 is further split into a beam 212 and a beam 213. The fully linearly polarized beam 208 and the fully linearly polarized beam 209 are orthogonal to each other. When the fully linearly polarized beam 208 reaches the side 257 of the fixed wedge 251, the beam 208 is split into beams 253 and 254, the angle between beam 253 and beam 254 is θ, and θ is very small, for example, θ=3° (0.05 rad). When the fully linearly polarized beam 209 reaches the side 257 of the fixed wedge 251, the beam 109 is also split into beams 255 and 256, the angle between beam 255 and beam 256 is also θ, and θ is very small, for example, θ=3° (0.05 rad). θ can be estimated by the formula: θ≈b·α, where b is the birefringence of the material, b=nₒ−nₑ, where nₒ and nₑ are the ordinary and extraordinary refractive indices, α is the wedge angle. For example, when b=0.1, and α=16°, θ≈b·α=1.6°. The side 257 and the side 258 are parallel to each other, the side 257 and the side 258 are separated by air, the distance between the side 257 and the side 258 is d, d is very small, for example, d=0.2 mm=200 μm. When the moving wedge 252 moves along the direction 259, side 257 and side 258 are always parallel to each other and the distance d is maintained as a constant. When beams 253 and 254 reach side 258, they become beams 210 and 211, respectively, the distance between beams 210 and 211 is δ, an estimate of δ based on d and θ is: δ˜d·θ˜10 μm. When beams 255 and 256 reach side 258, they become beams 212 and 213, respectively, the distance between beams 212 and 213 is also δ, an estimate of δ based on d and θ is also: δ˜d·θ˜10 μm. Typical wedges available on the market possess cross section of right triangle, or isosceles triangle, but it is obvious for one skilled in the art that the cross sections of the birefringent wedges do not have to be right triangle or isosceles triangle, such cross sections are not meant to limit the scope of current invention.

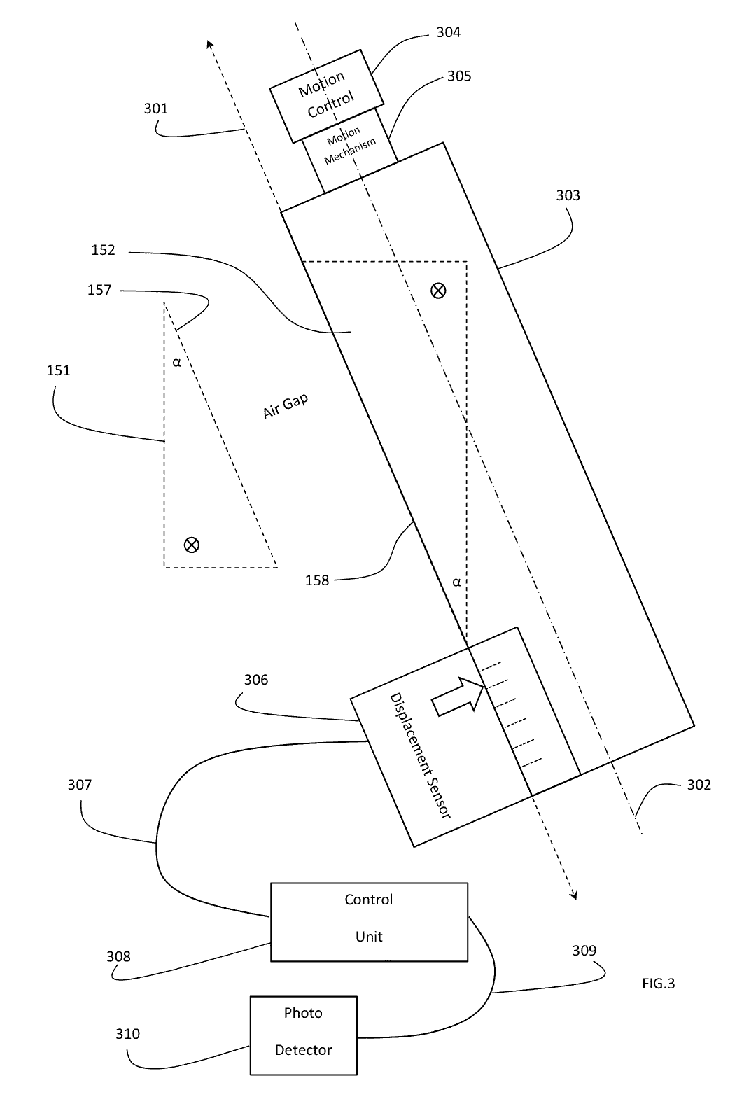

As shown in FIG. 3, a schematic illustration of the moving mechanism of the moving birefringent wedges. The fixed wedge 151 and the moving wedge 152 are similar triangles, the side 157 of the fixed wedge 151 and the side 158 the moving wedge 152 are parallel to each other. When the moving wedge 152 moves along the direction 159, side 157 and side 158 are always parallel to each other and the distance d is maintained as a constant. A track 301 contains the moving direction of the moving wedge 152, the track 301 is parallel to the side 158 of the moving wedge 152, and the track 301 is also parallel to the side 157 of the fixed wedge 151. The moving wedge 152 sits on a holder 303, the holder 303 is so deployed to enable moving wedge 152 to move in the direction of the track 301, and at the same time, when the moving wedge 152 moves along the direction of the track 301, side 157 and side 158 are always parallel to each other and the distance d is maintained as a constant. A central axis 302 of the holder 303 is parallel to the track 301, and parallel to sides 157 and 158. A motion mechanism 305, typically an electric precision motor, is in mechanical contact with the holder 303 and the moving wedge 152 to enable linear movement of the moving wedge 152 along the direction of the track 301. The side 157 and the side 158 are always parallel to each other and the distance d is maintained as a constant. A motion control 304 is in connection with the motion mechanism 305 to implement precision movement of the moving wedge 152, the motion control 304 can also be in connection with other control modules in the system. In one implementation, a displacement sensor 306 is in rigid mechanical contact with the holder 303 and the moving wedge 152. The displacement sensor 306 reads out movement data of the moving wedge 152 with high precision. The movement data read out by the displacement sensor 306 is then forwarded to a control unit 308 through a cable 307. The high precision movement data is then combined with preset geometry data and material data of the moving wedge 152 to compute the change in optical path. A photo detector 310 detects photon energy and sends such data to the control unit through a cable 309, in the control unit, all data are combined to compute high sensitive spectrum of the radiation source.

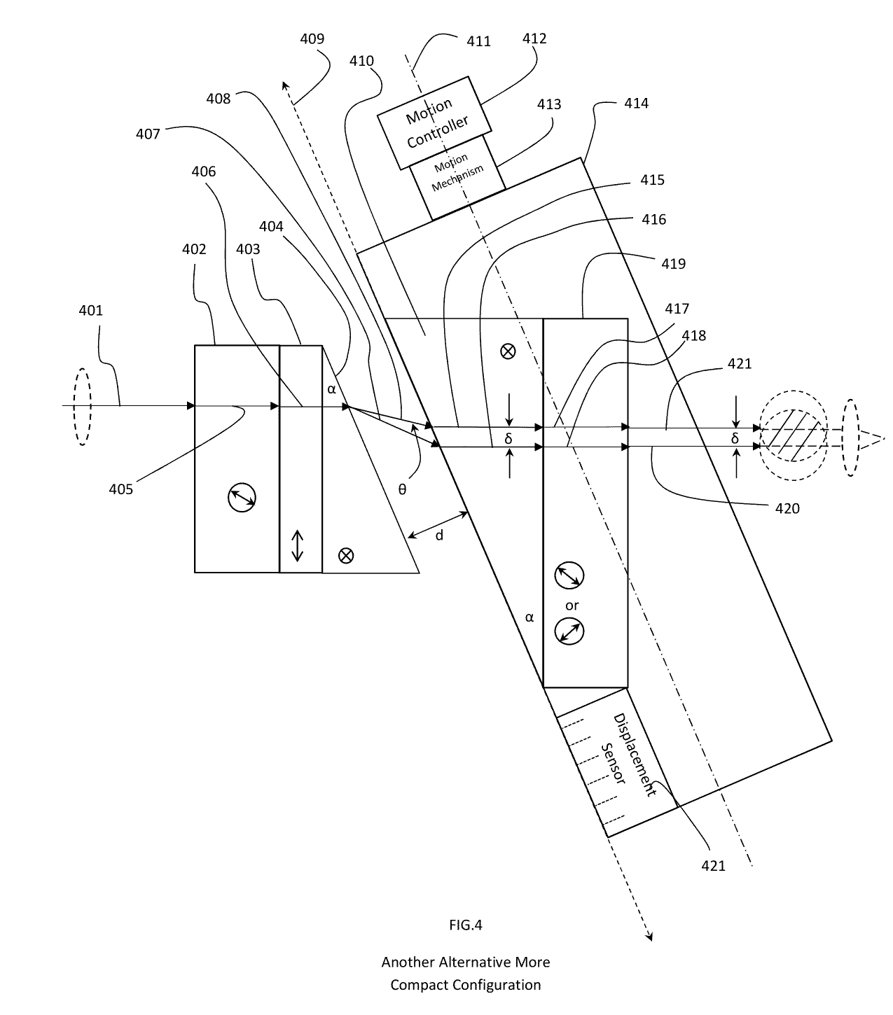

As shown in FIG. 4, an alternative implementation with relative compact configuration. A compact configuration of high sensitive Fourier-transform spectrometer comprises, a first polarizer 402, a birefringent plate 403, and a fixed birefringent wedge 404, a moving birefringent wedge 410, a second polarizer 419, a motion mechanism 413, a motion controller 412, a holder 414 and a displacement sensor 421.

The polarizer 402, the birefringent plate 403 and the fixed birefringent wedge 404 are not separated by air, where the polarizer 402 is in direct rigid physical contact with one side of the birefringent plate 403, the other side of the birefringent plate 403 is in direct rigid physical contact with the fixed birefringent wedge 404. The moving birefringent wedge 410 and the second polarizer 419 are not separated by air. The moving birefringent wedge 410 is in direct rigid physical contact with the second polarizer 419 in such a way that the second polarizer 419 always moves with the moving birefringent wedge 410. The holder 414 is in direct and rigid physical contact with the moving birefringent wedge 410 and the second polarizer 419. The displacement sensor 421 is in direct and rigid physical contact with the holder 414. The fixed wedge 404 and the moving wedge 410 are similar triangles with same wedge angle α, the corresponding sides of the fixed wedge 404 and the corresponding sides of the moving wedge 410 are parallel to each other. The optical axis of the fixed wedge 404 and the moving wedge 410 are parallel to each other and the optical axis of the birefringent plate 403 is orthogonal to the optical axis of both the fixed wedge 404 and the moving wedge 410. The angle between the polarization of first polarizer 402 and the optical axis of birefringent plate 403 is 45 degrees. The angle between the polarization of the first polarizer 402 and the optical axis of birefringent wedges 404 and 410 is also 45 degrees. The polarization of the second polarizer 419 is either parallel to the polarization of the first polarizer 402, or orthogonal to the polarization of the first polarizer 402. An incoming beam 401 is passed through the first polarizer 402 and becomes linearly polarized beam 405. The linearly polarized beam 405 is further passed into the birefrigent plate 403, and then passed into the fixed birefringent wedge 404. When the fully linearly polarized beam 406 reaches the side of the fixed wedge 404, the beam 406 is split into beams 407 and 408, the angle between beam 407 and beam 408 is θ, and θ is very small, for example, θ=3° (0.05 rad). The side of the fixed wedge 404 and the side of the moving wedge 410 are parallel to each other, and the side of the fixed wedge 404 and the side of the moving wedge 410 are separated by air, the distance between the side of wedge 404 and the side of wedge 410 is d, d is very small, for example, d=0.2 mm=200 μm. When the moving wedge 410 moves along the direction 409, the side of the fixed wedge 404 and the side of the moving wedge 410 are always parallel to each other and the distance d is maintained as a constant. When beams 407 and 408 reach the side of moving wedge 410, they become beams 415 and 416, respectively, the distance between beams 415 and 416 is δ, an estimate of δ based on d and θ is: δ˜d·θ˜10 μm. When beams 415 and 416 enter the second polarizer 419, they become beams 417 and 418. The beams 417, 418 are passed through the second polarizer 419 to become beams 420 and 421, the distance between beams 420 and 421 is also δ, δ˜d·θ˜10 μm.

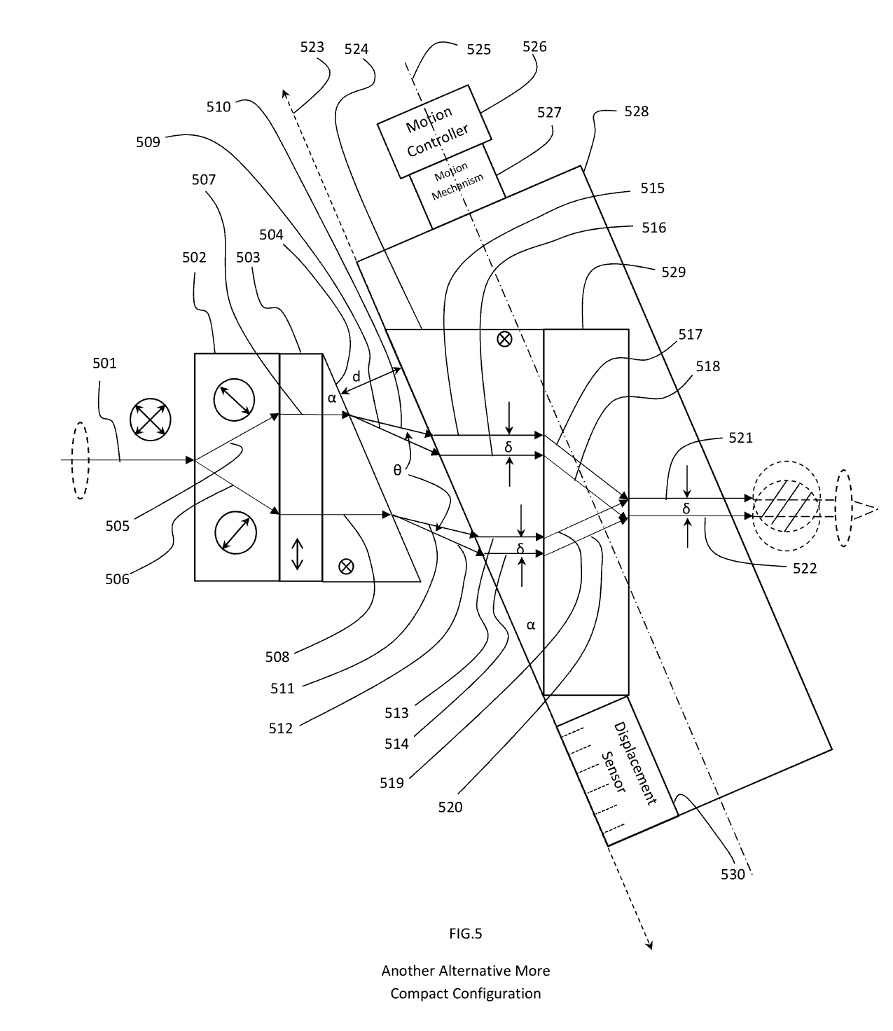

As shown in FIG. 5, an alternative implementation with relative compact configuration. A compact configuration of high sensitive Fourier-transform spectrometer comprises: a polarizing beam splitter 502, a birefringent plate 503, a fixed birefringent wedge 504, a moving birefringent wedge 524, a polarizing beam combiner 529, a motion controller 526, a motion mechanism 527, a holder 528 and a displacement sensor 530.

The polarizing beam splitter 502, the birefringent plate 503 and the fixed birefringent wedge 504 are not separated by air, wherein the polarizing beam splitter 502 is in direct rigid physical contact with one side of the birefringent plate 503, the other side of the birefringent plate 503 is in direct rigid physical contact with the fixed birefringent wedge 504. The moving birefringent wedge 524 and a polarizing beam combiner 529 are not separated by air. The moving birefringent wedge 524 is in direct rigid physical contact with the polarizing beam combiner 529 in such a way that the polarizing beam combiner 529 always moves with the moving birefringent wedge 524. The holder 528 is in direct and rigid physical contact with the moving birefringent wedge 524 and the polarizing beam combiner 529. The displacement sensor 530 is in direct and rigid physical contact with the holder 528. The fixed wedge 504 and the moving wedge 524 are similar triangles with same wedge angle α, the corresponding sides of the fixed wedge 504 and the corresponding sides of the moving wedge 524 are parallel to each other. The optical axis of the fixed wedge 504 and the moving wedge 524 are parallel to each other, the optical axis of the birefringent plate 503 is orthogonal to the optical axis of both the fixed wedge 504 and the moving wedge 524. An incoming beam 501 is split into linearly polarized beam 505 and linearly polarized beam 506, wherein, the polarization of beam 505 and 506 are orthogonal to each other. The linearly polarized beam 505 is further split into beam 509 and beam 510, linearly polarized beam 506 is further split into beam 511 and beam 512. When the fully linearly polarized beam 507 reaches the side of the fixed wedge 504, the beam 507 is split into beams 509 and 510, the angle between beam 509 and beam 510 is θ, and θ is very small, for example, θ=3° (0.05 rad). When the fully linearly polarized beam 508 reaches the side of the fixed wedge 504, the beam 508 is also split into beams 511 and 512, the angle between beam 511 and beam 512 is also θ, and θ is very small, for example, θ=3° (0.05 rad). The side of the fixed wedge 504 and the side of the moving wedge 524 are parallel to each other, the side of the fixed wedge 504 and the side of the moving wedge 524 are separated by air, the distance between the side of the fixed wedge 509 and the side of the moving wedge 524 is d, d is very small, for example, d=0.2 mm=200 μm. When the moving wedge 524 moves along the direction 523, the side of the fixed wedge 504 and the side of the moving wedge 524 are always parallel to each other and the distance d is maintained as a constant. When beams 509 and 510 reach the side of moving wedge 524, they become beams 516 and 515, respectively, the distance between beams 515 and 516 is δ, an estimate of δ based on d and θ is: δ˜d·θ˜10 μm. When beams 511 and 512 reach the side of the moving wedge 524, they become beams 513 and 514, respectively, the distance between beams 513 and 514 is also δ, an estimate of δ based on d and θ is also: δ˜d·θ˜10 μm. When beams 515 and 516 enter the polarizing beam combiner 529, they become beams 517 and 518, and when beams 513 and 514 enter the polarizing beam combiner 529, they become beams 519 and 520. The beams 517, 518, 519 and 520 are combined by the polarizing beam combiner 529 to become beams 521 and 522, the distance between beams 521 and 522 is also δ, δ˜d·θ˜10 μm.

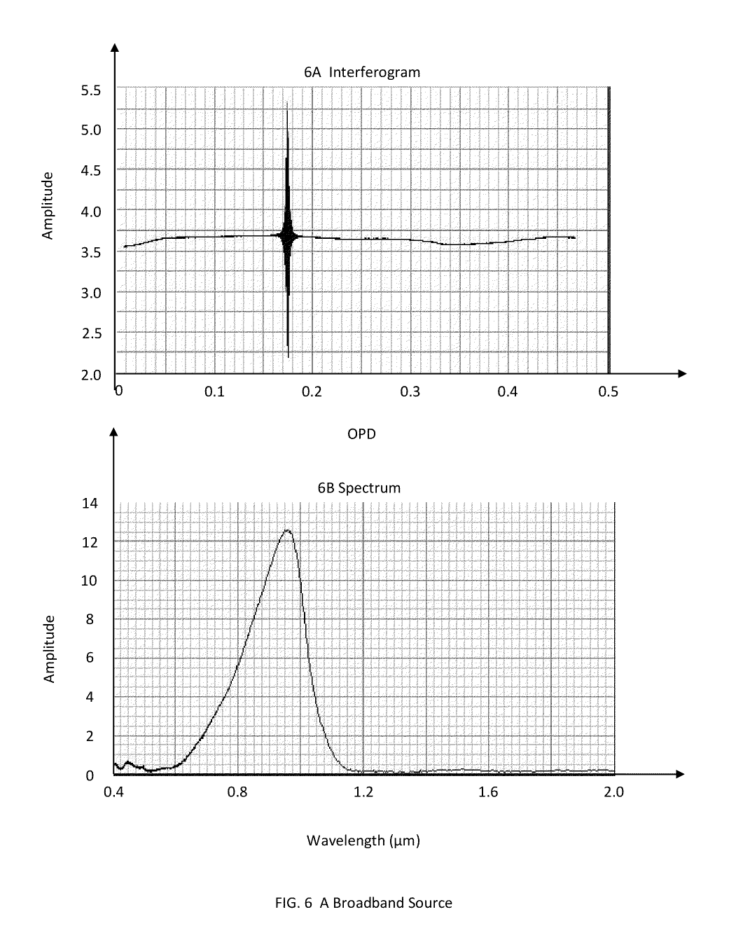

As shown in FIG. 6, an example interferogram raw data and resulting spectrogram for a broadband source obtained by the Fourier-transform spectrometer disclosed in the present invention. 6A is the interferogram where x axis is OPD, or optical path difference, and y axis is amplitude; 6B is the spectrum of the source where x axis is wavelength in μm and y axis is the amplitude.

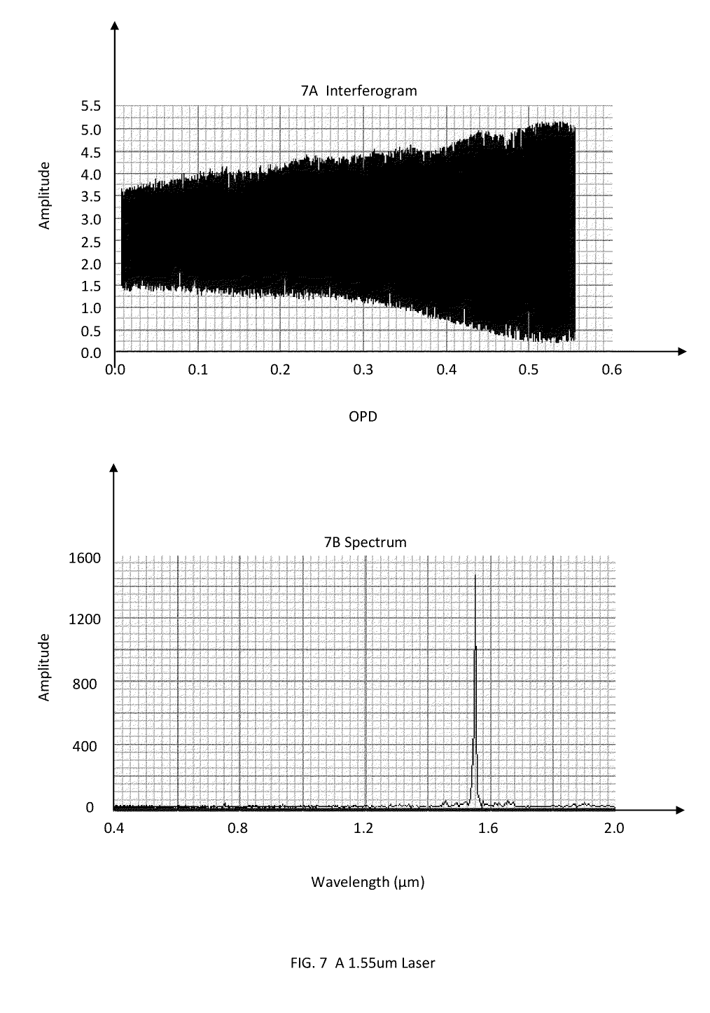

As shown in FIG. 7, an example interferogram raw data and resulting spectrogram for a laser source obtained by the Fourier-transform spectrometer disclosed in the present invention, where the wavelength of the laser is 1.55 μm. 7A is the interferogram where x axis is OPD, or optical path difference, and y axis is amplitude; 7B is the spectrum of the source where x axis is wavelength in μm and y axis is the amplitude.

For each position pᵢ of the moving wedge in FIG. 1, there is a corresponding optical path difference OPDᵢ between the polarizing beams 109 and 110, the optical path difference is determined by the geometry of the wedges, i.e. the shape of the right angle, and the refractive index of the wedges. For each OPDᵢ there is a corresponding amplitude Aᵢ detected by the photo detector. When the position pᵢ is adjusted N times, it produces N different optical path difference, OPD, values and N corresponding amplitude A values, which can be represented as [OPDᵢ, Aᵢ], i=1, 2, 3, . . . , N. [OPDᵢ, Aᵢ] can be plotted to produce interferogram, and the Fourier-transform of the interferogram produces corresponding spectrum of the incoming radiation. As illustration in FIG. 6, it is an example where the incoming radiation is a typical broadband source. 6A is the interferogram where x axis is the OPD, or optical path difference, and y axis is the amplitude, or A; 6B is the Fourier-transform of the data in 6A, it is the corresponding spectrum of the radiation source, where x axis is wavelength in μm and y axis is amplitude. As illustrated in FIG. 7, it is an example where the incoming radiation is laser. 7A is the interferogram where x axis is the OPD, or optical path difference, and y axis is the amplitude, or A; 7B is the Fourier-transform of the data in 7A, it is the corresponding spectrum of the radiation source, where x axis is wavelength in μm and y axis is amplitude. As can be observed in 7B, the peak of the amplitude in the spectrum is 1.55 μm.

In FIG. 6 and FIG. 7, the resolution of interferogram is determined by the resolution of OPD: the number of OPD data points obtained within a given optical path difference region. The number of OPD data points obtained within a given optical path difference region is determined by the fining tuning of the position pᵢ of the moving wedge. The ability of finer tuning can be increased when the wedge angle α of the both the moving wedge and the fixed wedge is reduced. The ability of fine tuning can also be increased when high precision motion and control mechanisms for the moving wedge are implemented. The ability of fine tuning also requires high resolution recording of the positions of the moving wedge, for example, the positions of the moving wedge can be recorded by an encoder. The displacement of the moving wedge can also be measured by another high precision interferometer.

Many modifications and other embodiments of the invention will come to the mind of one skilled in the art having the benefit of the teaching presented in the forgoing descriptions and the associated drawings. Such variations are within the scope of this disclosure. It is to be understood that the invention is not to be limited to the specific embodiments disclosed and that the modifications and embodiments are intended to be included within the scope of the dependent claims.

What is claimed is:

1. A Fourier-transform spectrometer arrangement, comprising:
a first polarizer;
a birefringent plate;
a pair of birefringent wedges;
a second polarizer;
a photo detector for receiving and recording output optical signal; and
a control unit for receiving data and computing resulting spectrum,
wherein the first polarizer polarizes an incoming radiation beam into linearly polarized beam;
wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air,
wherein the first wedge is fixed, and the second wedge is capable of linearly movement along the side,
wherein the optic axes of the pair of birefringent wedges are parallel to each other and orthogonal to the optic axis of the birefringent plate,
wherein the polarization of the first polarizer is in 45 degrees with the optical axis of the birefringent plate, and the polarization of the first polarizer is also in 45 degrees with the optical axis of the pair of birefringent wedges,
wherein the polarization of the second polarizer is parallel, or orthogonal, to the polarization of the first polarizer.

2. A Fourier-transform spectrometer arrangement in claim 1, further comprises:
a track parallel to the side of the moving wedge;
a holder capable of moving along the track and in rigid physical contact with the moving wedge;
a motion mechanism in mechanical contact with the holder and the moving wedge;
a motion controller in electronic connection with the motion mechanism to control the motion;
a displacement sensor unit for reading out position information from the wedge;
a control unit, in electronic connection with the decoder to receive position information of the moving wedge, in electronic connection with the photo detector for receiving radiation intensity information.

3. A Fourier-transform spectrometer arrangement in claim 2, wherein, the motion mechanism is a motor, and the motion controller is a motor controller.

4. A Fourier-transform spectrometer arrangement in claim 2, wherein, the displacement sensor unit is a position encoder and a decoder.

5. A Fourier-transform spectrometer arrangement in claim 2, wherein, the first polarizer and the birefringent plate are in direct rigid physical contact and not separated by air, the birefringent plate and the fixed wedge are in direct rigid physical contact and not separated by air; wherein, the moving wedge and the second polarizer are in direct rigid physical contact and not separated by air.

6. A Fourier-transform spectrometer arrangement in claim 5, wherein all components are integrated in a compact configuration for mobile deployment.

7. A method for performing Fourier-transform analysis, comprising the steps of:
polarizing an incoming beam of radiation into linearly polarized beams;
passing the linearly polarized beams through a birefrigent plate;
passing the beams through a pair of birefringent wedges;
passing the beams through a second polarizer;
detecting the resulting beam signal with a photo detector;
sending the information detected by the photo detector to a control unit;
adjusting the position of the moving wedge and detecting a new signal in the photo detector; and
repeating the process of adjusting the position of the moving wedge and computing the spectrum from of the incoming radiation,
wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air;
wherein the first wedge is fixed, and the second wedge is capable of linearly movement along the side;
wherein the optic axes of the pair of birefringent wedges are parallel to each other and orthogonal to the optic axis of the birefringent plate;
wherein the polarization of the first polarizer is in 45 degrees with the optical axis of the birefringent plate, and the polarization of the first polarizer is also in 45 degrees with the optical axis of the pair of birefringent wedges;
wherein the polarization of the second polarizer is parallel, or orthogonal, to the polarization of the first polarizer.

8. A Fourier-transform spectrometer arrangement, comprising:
a polarizing beam splitter;
a birefringent plate;
a pair of birefringent wedges;
a polarizing beam combiner;
a photo detector for receiving and recording output optical signal; and
a control unit for receiving data and computing resulting spectrum,
wherein the polarizing beam splitter splits an incoming radiation beam into two orthogonal linearly polarized beams;
wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air;
wherein the first wedge is fixed, and the second wedge is capable of linearly movement along the side;
wherein the optic axes of the pair of birefringent wedges are parallel to each other and orthogonal to the optic axis of the birefringent plate.

9. A Fourier-transform spectrometer arrangement in claim 8, wherein further comprising:
a track parallel to the side of the moving wedge;
a holder capable of moving along the track and in rigid physical contact with the moving wedge;
a motion mechanism in mechanical contact with the holder and the moving wedge;
a motion controller in electronic connection with the motion mechanism to control the motion;
a position measurement unit for reading out position information from the wedge; and
a control unit, in electronic connection with the decoder to receive position information of the moving wedge, in electronic connection with the photo detector for receiving radiation intensity information.

10. A Fourier-transform spectrometer arrangement in claim 8, wherein, the motion mechanism is a motor, and the motion controller is a motor controller.

11. A Fourier-transform spectrometer arrangement in claim 8, wherein, the position measurement unit is a position encoder and a decoder.

12. A Fourier-transform spectrometer arrangement in claim 8, wherein, the polarizing beam splitter and the birefringent plate are in direct rigid physical contact and not separated by air, the birefringent plate and the fixed wedge are in direct rigid physical contact and not separated by air; wherein, the moving wedge and the polarizing beam combiner are in direct rigid physical contact and not separated by air.

13. A Fourier-transform spectrometer arrangement in claim 8, wherein all components are integrated in a compact configuration for mobile deployment.

14. A method for performing Fourier-transform analysis, comprising the steps of:
splitting an incoming beam of radiation into two orthogonal linearly polarized beams;
passing the linearly polarized beams through a birefrigent plate;
passing the beams through a pair of birefringent wedges;
passing the beams through a polarizing beam combiner;
detecting the resulting beam signal with a photo detector;
sending the information detected by the photo detector to a control unit;
adjusting the position of the moving wedge and detecting a new signal in the photo detector; and
repeating the process of adjusting the position of the moving wedge and computing the spectrum from of the incoming radiation,
wherein the cross sections of the two birefringent wedges of the birefringent wedge pair are similar triangles, the corresponding sides of the first wedge are parallel to the corresponding sides of the second wedge, the wedge angle of the first wedge and the wedge angle of the second wedge pointing to opposite directions, the side of the first wedge and the side of the second wedge are separated by air;
wherein the first wedge is fixed, and the second wedge is capable of linearly movement along the side;
wherein the optic axes of the pair of birefringent wedges are parallel to each other and orthogonal to the optic axis of the birefringent plate.
